(19) United States
(12) Patent Application Publication
(10) Pub. No.: US 2023/0191578 A1
(43) Pub. Date: Jun. 22, 2023

(54) Air Hammer Cone Washer Removal Tool

(71) Applicant: Robert Bosch GmbH, Stuttgart (DE)

(72) Inventors: Robert Kochie, Dodge Center, MN (US); Robert Jensen, Clarks Grove, MN (US); Dennis Hanson, Medford, MN (US)

(21) Appl. No.: 17/558,685

(22) Filed: Dec. 22, 2021

(51) Int. Cl. B25D 17/02; B25D 17/08; B25D 9/00

(52) U.S. Cl. CPC B25D 17/02; B25D 9/00; B25D 17/08; B25D 2250/111

(57) ABSTRACT

An air hammer tool having a head section defining a blind-hole and a contact surface surrounding the blind-hole, configured to be coupled with an air hammer to provide a percussive force through the contact face of the tool to an axle flange around an axle shaft flange hole, after a flange nut has been removed, to shock a cone-washer disposed therein. The design and solution to this long-felt issue allows for easier removal of the cone-washers from the axle shaft flange holes while not contacting the respective studs and lowering chances for damage of the axle componentry.

### TECHNICAL FIELD

This disclosure relates to tools and adapters, and more specifically to tools and adapters utilized with an air hammer for vehicle repair.

### BACKGROUND

An air hammer, also known as an air chisel, and as used in this disclosure, is a pneumatic percussive hand-held device originally designed in the 1920s and 1930s to carve in stone, and to cut or shape metal objects. :=W air hammer is designed to accept different tools, also known as adapters, bits, chisels, or inserts, although other names have been used, to impart a reciprocating force from the air hammer thru the tool into a contacted object. The reciprocating force has a driving force with a driving force direction, and a return force, with a return force direction, which may or may not be linear. The air hammer has a receptacle configured to receive an air hammer tool. Most modem air hammers utilize a spring to retain an air hammer tool.

One example of an air hammer tool comes from the OTC 4559 Manual/Pneumatic Pickle Fork Set, which can be viewed at https:Wwwwv.otctools.com/products/manual-pneuina.tic-pickle-fork-set. The set contains three fork heads of different sizes that may be connected to two different handles, one for manually holding/aligning with a hand and striking the end with a hammer, and the other is an adapter for use with an air hammer. The fork heads are tapered increasing in thickness from a primary contact end and, when used with the reciprocating percussive force of an air hammer, improve a user’s ability to separate automotive ball joints, tie rods, and Pitman arms.

Another example of an air hammer tool comes from the OTC 2545 Door Flange Tool Set, which can be viewed at https://www.otctools.com/products/door-flange-tool-set. The set includes right and left hand door hem flange opening air hammer adapters, a pack of 10 hem flange tool replacement inserts, and a door hem flange crimping tool. The door hem flange opening adapters are designed to aid in vehicular aluminum door repair and, when used with the reciprocating percussive force of an air hammer, allow for improved removal of aluminum door skins by a more controlled uncrimping of a flange between the aluminum skin and the structure of the door.

Yet another example of an air hammer tool is the OTC 7302-2 Brake Caliper Pin Bolt Remover, which can be seen at https://www.otctools;com/products/brake-caliper-pinbolt-remover-air-hammer. Brake caliper pins on vehicles allow the caliper to float on the rotor, but after time these may become seized causing improper brake pad and rotor wear. This tool, when used with the reciprocating percussive force of an air hammer, aids in the removal of frozen caliper pins by allowing a more controlled reciprocating striking force tz3 be applied to, or near, the pin, while not damaging the pin or bolt like a chisel or punch could.

FIG. 6 shows an illustrative view of a heavy-duty, powered, non-steering (full-floating) axle assembly 104 including a hub assembly 108 and an axle half-shaft 109. Axle assembly 104 is illustrative of a kind of axle assembly most commonly used in medium and heavy duty trucks, although the design has been used with other vehicles. The axle half-shaft 109 has an axle shaft flange 110 on a protruding end. The axle shaft flange 110 is attached to hub assembly 108 by means of studs 118 (see FIG. 7), flange-nuts 120, and cone-washers 121. The inner end of the axle half-shaft 109, such as that shown in this illustrative view, is typically splined and engaged with a differential drive (not shown).

FIG. 7 shows an illustrative exploded view of the hub assembly 108 and the axle half-shaft 109, similar to the hub assembly 108 and axle half-shaft 109 shown in FIG. 6. The axle half-shaft 109 is provided with the axle shaft flange 110 having conically-bored axle shaft flange holes 129, and is shown partially inserted into the hub assembly 108. An axle shaft seal 116 is shown in its relative position which is designed to restrict the egress of axle lubricant that is contained within the axle housing of axle assembly 104. As mentioned above, the fasteners are shown, consisting of the studs 118, the flange-nuts 120, and the cone-washers 121. By means of the studs 118, the flange-nuts 120, and the cone-washers 121, tire axle shaft flange 110 is attached to the hub assembly 108. When the flange-nuts 120 are tightened on the studs 118, the cone-washers 121 are at least partially disposed and extend within the conically-bored axle shaft flange holes 129.

The axle assembly 104 on many medium and heavy duty trucks have utilized this form of affixing hub assemblies 108 to half-shafts 109. Tire cone-washers 121 help to center the hub assembly 118 on the half-shaft 109, which is important for the minimization of non-concentric vibration. The cone-washers 121, when the hub assembly 108 is assembled as shown in FIG. 7, typically <io not protrude much, if any, above the face surface of the axle shaft flange 110, and may plastically deform near or around the face of the flange 110, which can add to the difficulty of removal when servicing. In practice, a high number of hammer blows are typically required to loosen them up, however the use of hammer blows can cause damage. And adhesives such as Loctite may have been added to the cone-washers 121, or to the studs 118 that then has bled onto the cone-washers 121, causing even more difficulty in their removal.

A Jan. 8, 2012 YouTube video showcases the challenge of the removal of such cone-nuts from a 1976 Winnebago with what is believed to be a Dana 70 rear axle, and may be viewed at https://www.youtube.comwatch?v=Y11ei1RooHg. This video being nearly ten years old at the time of this innovation, and to service a vehicle nearly 50 years old, supports a long felt need for an improved solution to remove cone-nuts from these types of axle assemblies. And a solution to utilize a tool for an air hammer, a device that has been in use for nearly 100 years, as described and claimed below, supports the non-obviousness of such a solution.

### SUMMARY

One aspect of this disclosure is directed to an air hammer tool that has a first section and a second section. The first section has an insert portion, shaft portion, and retaining nub portion disposed therebetween. The insert portion, shaft portion, and retaining nub portion all together define a axis. The insert portion extends along the axis from an end face at a first outer-diameter. The retaining nub portion extends from the insert portion along the axis, increasing to a second outer-diameter greater than the first outer-diameter, and returning to a third outer-diameter smaller than the second outer diameter. The shaft portion extends from the retaining nub portion along the axis at the third outer-diameter. A portion of this first section is configured to be insertable into an air hammer.

The second section of this tool extends from the first section. In some embodiments there may be additional sections between the first and second sections, such as a transition section or coupling section. The second section has a head portion with a fourth outer-diameter. The fourth outer-diameter of the head section is larger than the third outer-diameter of the shaft portion. The head portion has a contact face. The contact face is substantially orthogonal to the axis. The head portion also defines a blind-hole extending inwardly from the contact face. The blind-hole has an inner-diameter smaller than the fourth outer-diameter.

This aspect may provide for the blind-hole inner-diameter to be substantially circular as it extends from the contact face into the second section. This aspect may also provide for the fourth outer-diameter to be substantially circular as it extends along the head portion.

The blind-hole may also be configured to extend inwardly from the contact face to a depth sufficient to be disposable over a stud extending through an axle shaft flange with a flange nut removed of a vehicle axle utilizing studs, cone washers, and flange nuts to secure a hub assembly to an axle half-shaft. In this embodiment, the blind-hole may extend inwardly from the contact face to a full diameter depth of at least 1.8 inches.

The inner-diameter of the blind-hole may be configured to be disposable over a stud extending through an axle shaft flange with a flange nut removed of a vehicle axle utilizing studs, cone washers, and flange nuts to secure a hub assembly to an axle half-shaft. In this embodiment, the inner-diameter of the blind-hole may be at least 1.0 inches.

Additionally, the difference between the inner-diameter of the blind-hole and the fourth outer-diameter of the second section may provide a wall thickness in the second section of at least 0.35 inches. Further the third outer-diameter of the tool may be larger than or equal to the first outer-diameter. And the first and second sections may be a single unitary piece.

Another aspect of this disclosure is directed to an air hammer tool for use on a vehicle axle utilizing studs, cone washers, and flange nuts in combination to secure a hub assembly to an axle shaft flange. In this aspect, a first section of the tool is configured to be insertable within an air hammer, and a second section is opposite the first section, the second section having a contact face and defining a blind-hole extending inwardly from the contact face.

In this aspect, an air hammer is configured to provide a driving force motion direction, and, when the air hammer tool is inserted within an air hammer, the contact face of the tool may be configured to be substantially orthogonal to the driving force motion direction.

Additionally, the contact face may be configured to, after a flange nut is removed, at least partially contact the axle shaft flange at least partially around a cone-washer. To accomplish this, the blind-hole may have an inner-diameter of at least 1.0 inches. As well, the contact face may have a thickness of at least 0.35 inches extending radially outwardly from the inner-diameter of the blind-hole. The blind-hole may be further configured to be disposable over a stud extending through the cone-washer. In this aspect, the blind-hole may extend inwardly from the contact face to a full diameter depth of at least 1.8 inches.

A further aspect of this disclosure is directed to an air hammer tool having a body with a first section configured to couple with an air hammer, and a second section defining a blind-hole extending inwardly from a contact face. In this aspect, the contact face is configured to, after a flange nut has been removed, contact an axle shaft flange substantially around an axle shaft flange hole with a cone-washer at least partially disposed therein. The contact face is configured to impart a percussive force from an air hammer thru the contact face into an axle shaft flange to shock a cone-washer.

In this aspect the blind-hole may extend inwardly from the contact face to a depth sufficient to be disposable over a stud extending through the cone-washer. As well, the blind-hole may be substantially circular.

The above aspects of this disclosure and other aspects will be explained in greater detail below with reference to the attached drawings.

### BRIEF DESCRIPTION OF THE DRAWINGS

FIG. 1 is a side view of an air hammer cone washer removal tool.

FIG. 2 is a cross-sectional view taken along line 2-2 in FIG. 1.

FIG. 3 is a first perspective view of an air hammer cone washer removal tool.

FIG. 4 is a second perspective view of an air hammer cone washer removal tool.

FIG. 5 is an end view of an air hammer cone washer removal tool.

FIG. 6 is illustrative view of an axle assembly identifying the location of a cone washer when assembled.

FIG. 7 is an illustrative exploded view of an axle half shaft extending through a hub assembly and the axle components used to couple the hub assembly to an axle shaft flange, including relative locations of cone washers.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

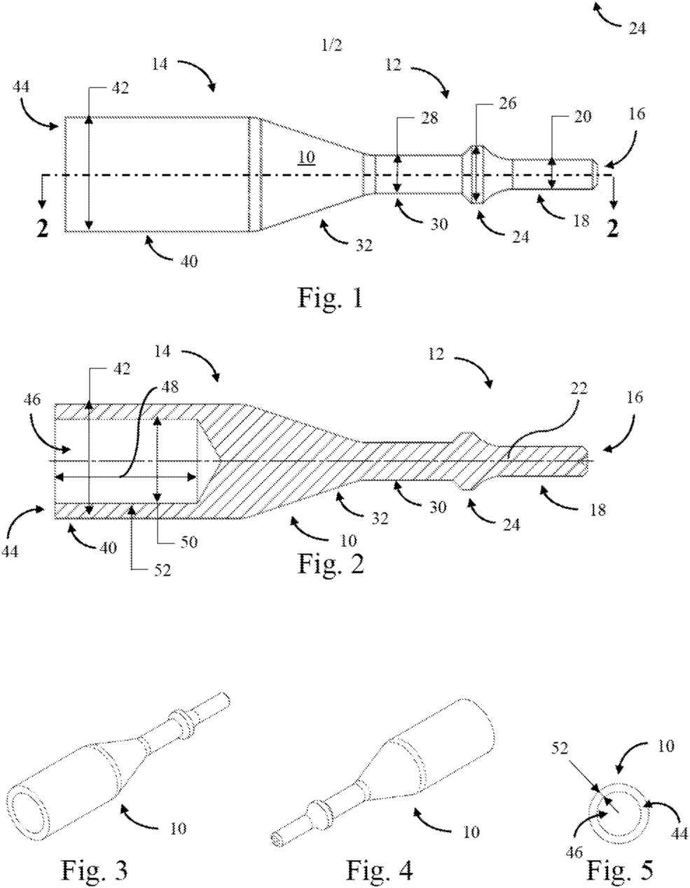

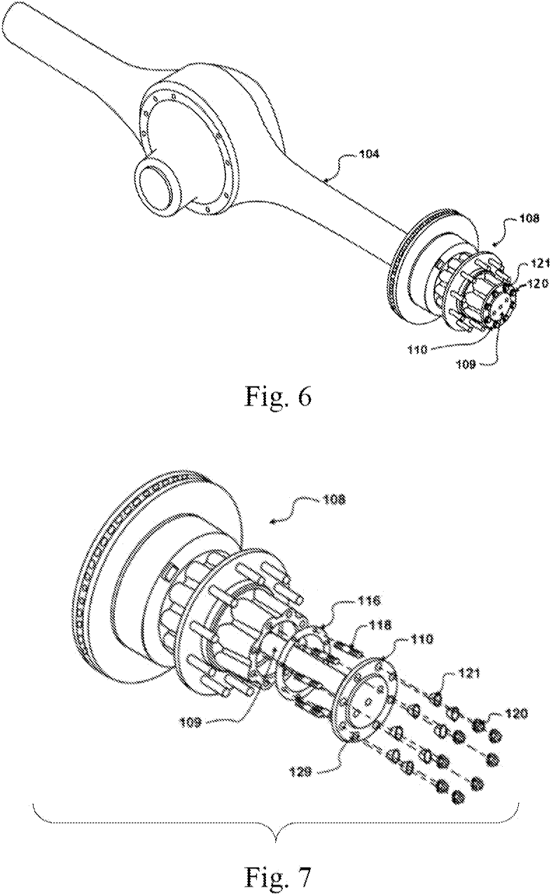

FIG. 1 shows an air hammer tool 10, and FIG. 2 shows a cross-sectional view taken along line 2-2 in FIG. 1. Air hammer tool 10 may also be referred to as an air hammer cone washer removal tool 10. Air hammer tool 10 may be used on a vehicle axle utilizing studs, cone washers, and flange nuts in combination to secure a hub assembly to an axle shaft flange (see FIGS. 6 & 7). FIGS. 1 and 2 show air hammer tool 10 having a first section 12 and a second section 14. At least a portion of the first section 12 is configured to be insertable within an air hammer (not shown), thus first section 12 is configured to couple with an air hammer. The second section 14 is configured to, after a flange nut is removed, to at least partially contact an axle shaft flange at least partially around a cone-washer (see FIGS. 6 & 7).

The air hammer tool 10 has an end face 16 shown on the far right of each figure. An insert portion 18 extends from the end face 16 at a first outer-diameter 20. The insert portion 18 of the first section 12 defines an axis 22. Axis 22 may be a central axis 22 to a tubular insert portion 18, however many different shapes may be used for insert portion 18, and the axis may be any straight line running longitudinally with the first section 12. Insert portion 18 extends along the axis 22 from the end face 16.

The first section 18 has a retaining nub portion 24 which extends from the insert portion 18 along the axis 22. The retaining nub portion 24 increases to a second outer-diameter 26. The second outer-diameter 26 is greater than the first outer-diameter 20. The retaining nub portion returns to a third outer-diameter 28. The third outer-diameter 28 is smaller than the second outer-diameter 26. The third outer-diameter 28 may be larger than or equal to the first outer-diameter 20. The first section 18 also has a shaft portion 30 extending from the retaining nub portion 24 along the axis 22, extending at the third outer-diameter 28. The retaining nub portion 24 is disposed between the insert portion 18 and the shaft portion 30.

The air hammer tool 10 has a second section 14 which extends from the first section 12 directly or via a transition section 32 or coupling section (not shown). A coupling section could provide a threaded portion to couple the second section 14 to the first section 12, or decoupled and recoupled to a hand-held segment for use with a hammer. The second section 14 has a head portion 40 at a fourth outer-diameter 42. The fourth outer-diameter 42 is larger than the third outer-diameter 28. The fourth outer-diameter 42 is substantially circular as it extends along the head portion 40. The head portion 40 ends at a contact face 44.

The contact face 44 is opposite the end face 16, and the contact face 44 is substantially orthogonal to the axis 22 of the insert portion 18. Substantially, as used within this application, means within +_{/}- 5 degrees. Although the contact face 44 is substantially orthogonal to the axis 22, the end face 16 need not be parallel with the contact face 44 nor orthogonal to the axis 22. When at least a portion of the first section 1 2 is inserted within an air hammer (not shown), the contact face 44 is configured to be substantially orthogonal to a driving force direction of the air hammer.

The head portion 40 defines a blind-hole 46. Alternatively, and possibly more broadly, the blind-hole 46 may be defined by the second section 14. The blind-hole 46 extends inwardly from the contact face 44. The blind-hole extends inwardly in the second section 14 to a depth 48 sufficient to be disposable over a stud extending through an axle shaft flange with a flange nut removed of a vehicle axle utilizing studs, cone washers, and flange nuts to secure a hub assembly to an axle half-shaft (see FIGS. 6 & 7). Said another way, the blind-hole extends inwardly in the second section 14 to a depth 48 sufficient to be disposable over a stud extending through the cone-washer. In one embodiment, the full diameter depth 48 of the blind hole 46 is at least 1.8 inches.

The blind-hole 46 may be substantially circular. Substantially, as used here, merely means that it does not have to be a perfect circle. In fact, it is envisioned that the head portion 40 and the blind-hole 46 may be an oval or a polygon. The operation of the air gun is to reciprocate in a direction along the longitudinal length of an air hammer tool inserted, and not to rotate like that of a drill, thus concentricity is not necessary.

The blind-hole has an inner-diameter 50. The inner-diameter 50 is smaller than the fourth outer-diameter 42. The inner-diameter 50 is larger than the first outer-diameter 20. The blind-hole inner-diameter 50 is substantially circular as it extends from the contact face 44 into the second section 14. The inner-diameter 50 of the blind-hole 46 is configured to be disposable over a stud extending through an axle shaft flange with a flange nut removed of a vehicle axle utilizing studs, cone washers, and flange nuts to secure a hub assembly to an axle half-shaft. The inner-diameter 50 of the blind-hole 46 is at least 1.0 inches.

The difference between the inner-diameter 50 of the blind-hole 46 and the fourth outer-diameter 42 of the head portion 40 define a wall thickness 52 in the second section 14. The wall thickness 52 is at least 0.35 inches thick around the blind-hole 46. The blind-hole 46 is configured to, after a flange nut is removed, at least partially contact the axle shaft flange at least partially around a cone-washer (see FIGS. 6 & 7). Said another way, the blind-hole 46 is configured to contact an axle shaft flange substantially around an axle shaft flange hole with a cone-washer at least partially disposed therein to impart a percussive force from the air hammer thru the contact face into the axle shaft flange to shock the cone-washer.

FIGS. 3 and 4 are first and second perspective views, respectively, of an air hammer cone washer removal tool 10. FIG. 5 is an end view of an air hammer cone washer removal tool 10 showcasing the contact face 44, the blind-hole 46, and the wall thickness 52 therein defined. Although shown as circular here, it is well mentioned again that it is envisioned to be of any shape such as an ellipse or polygonal shape, or any combination of the two.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. An air hammer tool, comprising:
a first section having an insert portion, shaft portion, and retaining nub portion disposed therebetween, the first section defining an axis, the insert portion extending along the axis from an end face at a first outer-diameter, the retaining nub portion extending from the insert portion along the axis, increasing to a second outer-diameter greater than the first outer-diameter and returning to a third outer-diameter smaller than the second outer diameter, and the shaft portion extending from the retaining nub portion along the axis at the third outer-diameter; and
a second section extending from the first section having a head portion with a fourth outer-diameter, the fourth outer-diameter being larger than the third outer-diameter, the head portion having a contact face substantially orthogonal to the axis, and the head portion defining a blind-hole extending inwardly from the contact face with an inner-diameter smaller than the fourth outer-diameter.

2. The air hammer tool of claim 1, wherein the blind-hole inner-diameter is substantially circular as it extends from the contact face into the second section.

3. The air hammer tool of claim 1, wherein the fourth outer-diameter is substantially circular as it extends along the head portion.

4. The air hammer tool of claim 1, wherein the blind-hole is configured to extend inwardly from the contact face to a depth sufficient to be disposable over a stud extending through an axle shaft flange with a flange nut removed of a vehicle axle utilizing studs, cone washers, and flange nuts to secure a hub assembly to an axle half-shaft.

5. The air hammer tool of claim 1, wherein the blind-hole extends inwardly from the contact face to a full diameter depth of at least 1.8 inches.

6. The air hammer tool of claim 1, wherein the inner-diameter of the blind-hole is configured to be disposable over a stud extending through an axle shaft flange with a flange nut removed of a vehicle axle utilizing studs, cone washers, and flange nuts to secure a hub assembly to an axle half-shaft.

7. The air hammer tool of claim 1, wherein the inner-diameter of the blind-hole is at least 1.0 inches.

8. The air hammer tool of claim 1, wherein the difference between the inner-diameter of the blind-hole and the fourth outer-diameter of the second section provide a wall thickness in the second section of at least 0.35 inches around the blind-hole.

9. The air hammer tool of claim 1, wherein the third outer-diameter is larger than or equal to the first outer-diameter.

10. The air hammer tool of claim 1, wherein the first and second sections are a single unitary piece.

11. An air hammer tool for use on a vehicle axle utilizing studs, cone washers, and flange nuts in combination to secure a hub assembly to an axle shaft flange, comprising:
a first section configured to be insertable within an air hammer, and a second section having a contact face and defining a blind-hole extending inwardly from the contact face.

12. The air hammer tool of claim 11, wherein an air hammer is configured to provide a reciprocating driving force direction, and when at least a portion of the first section is inserted within an air hammer, the contact face is configured to be substantially orthogonal to the driving force direction.

13. The air hammer tool of claim 11, wherein the contact face is configured to, after a flange nut is removed, at least partially contact the axle shaft flange at least partially around a cone-washer.

14. The air hammer tool of claim 13, wherein the blind-hole has an inner-diameter of at least 1.0 inches.

15. The air hammer tool of claim 14, wherein the contact face has a thickness of at least 0.35 inches around the blind-hole.

16. The air hammer tool of claim 15, wherein the blind-hole is further configured to be disposable over a stud extending through the cone-washer.

17. The air hammer tool of claim 16, wherein the blind-hole extends inwardly from the contact face to a full diameter depth of at least 1.8 inches.

18. An air hammer tool, comprising:
a first section configured to couple with an air hammer, and a second section defining a blind-hole extending inwardly from a contact face, the contact face configured to contact an axle shaft flange substantially around an axle shaft flange hole with a cone-washer at least partially disposed therein to impart a percussive force from the air hammer thru the contact face into the axle shaft flange to shock the cone-washer.

19. The air hammer tool of claim 18, wherein the blind-hole extends inwardly from the contact face to a depth sufficient to be disposable over a stud extending through the cone-washer.

20. The air hammer tool of claim 18, wherein the blind-hole is substantially circular.
